(19) United States
(12) Patent Application Publication
(10) Pub. No.: US 2025/0210764 A1
(43) Pub. Date: Jun. 26, 2025

(54) BATTERY

(71) Applicant: Toyota Jidosha Kabushiki Kaisha, Toyota-shi (JP)

(72) Inventor: Hiroyuki NAKAYAMA, Okazaki-shi (JP)

(73) Assignee: Toyota Jidosha Kabushiki Kaisha, Toyota-shi (JP)

(21) Appl. No.: 18/827,892

(22) Filed: Sep. 9, 2024

(30) Foreign Application Priority Data
Dec. 25, 2023 (JP) 2023-218349

(51) Int. Cl. H01M 50/184; H01M 4/02; H01M 10/0525; H01M 50/105; H01M 50/186; H01M 50/548; H01M 50/555

(52) U.S. Cl. CPC H01M 50/184; H01M 10/0525; H01M 50/105; H01M 50/186; H01M 50/548; H01M 50/555; H01M 2004/029

(57) ABSTRACT

A pair of laminate exterior bodies that covers the entire laminate obtained by laminating a plurality of electrodes including current collectors in a predetermined lamination direction with the laminate exterior bodies thermally welded to each other in a state where the entire laminate is interposed between the laminate exterior bodies includes conductive layers that are electrically connected to end portion current collectors that are the current collectors of the electrodes at both end portions of the laminate, first sealant layers provided on first surfaces of the conductive layers that are surfaces on the opposite sides of the conductive layers from the laminate, and laminate layers provided on surfaces of the first sealant layers that is on the opposite sides of the first sealant layers from the conductive layers and first folding target portions, second folding target portions, and third folding target portions are folded to have U-shaped sectional shapes.

### CROSS-REFERENCE TO RELATED APPLICATION

This application claims priority to Japanese Patent Application No. 2023-218349 filed on Dec. 25, 2023. The disclosure of the above-identified application, including the specification, drawings, and claims, is incorporated by reference herein in its entirety.

### BACKGROUND

### 1. Technical Field

The disclosure relates to a battery.

### 2. Description of Related Art

Disclosed in Japanese Unexamined Patent Application Publication No. 2005-276486 (JP 2005-276486 A) is a battery including a laminate obtained by laminating a plurality of electrodes each including a current collector in a predetermined lamination direction and a laminate exterior body that covers the entire laminate. The laminate exterior body includes a conductive layer that is electrically connected to the current collectors of the electrodes at both end portions of the laminate in the lamination direction. The laminate exterior body further includes a pair of laminate layers connected to a conductive layer and a sealing resin connected to outer peripheral edge portions of the laminate layers.

### SUMMARY

In a case where a laminate layer has a hole, a short circuit may occur between the conductive layer exposed through the hole and another conductor (for example, a conductive layer of another battery). Therefore, a sealant layer (a sealing material) is interposed between the laminate layer and the conductive layer in some cases. However, in such a case, a foreign substance, such as moisture, may enter a space radially inward of the laminate exterior body from, for example, the outside of the laminate exterior body when the size of the sealant layer is not large and the seal length of the sealant layer is not large. However, when the size of the sealant layer is large, there is a problem that the volume of the battery is large.

The disclosure has been made in consideration of the above-described circumstances and the disclosure provides a battery with which it is possible to make a foreign substance less likely to enter a space radially inward of a laminate exterior body from between a sealant layer and a member adjacent to the sealant layer without an increase in dimensions of the entire battery, the sealant layer being a member constituting the laminate exterior body.

A first aspect of the disclosure relates to a battery including a laminate and a pair of laminate exterior bodies. The laminate is obtained by laminating a plurality of electrodes including current collectors in a predetermined lamination direction. The laminate exterior bodies covers the entire laminate with the laminate exterior bodies thermally welded to each other in a state where the entire laminate is interposed between the laminate exterior bodies. Each of the laminate exterior bodies includes a conductive layer that is electrically connected to end portion current collectors that are the current collectors of the electrodes at both end portions of the laminate in the lamination direction, a first sealant layer that is provided on a first surface of the conductive layer that is a surface on the opposite side of the conductive layer from the laminate, and a laminate layer that is provided on a surface of the first sealant layer that is on the opposite side of the first sealant layer from the conductive layer. A first folding target portion that is a portion of the first sealant layer, a second folding target portion that is a portion of the laminate layer, and a third folding target portion that is a portion of the conductive layer are stacked on each other in a thickness direction of the laminate exterior body. The first folding target portion, the second folding target portion, and the third folding target portion are folded to have U-shaped sectional shapes.

As described above, with the battery according to the aspect of the disclosure, it is possible to make a foreign substance less likely to enter a space radially inward of a laminate exterior body from between a sealant layer and a member adjacent to the sealant layer, the sealant layer being a member constituting the laminate exterior body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of a battery according to an embodiment;

FIG. 2 is a schematic exploded perspective view of a laminate, a first exterior constituting portion, and a second exterior constituting portion, which are components of the battery according to the embodiment;

FIG. 3 is a schematic exploded perspective view of a first laminate exterior body;

FIG. 4 is a schematic perspective view of the first laminate exterior body in an unfolded state;

FIG. 5 is a sectional view taken along an arrow line V-V of FIG. 4;

FIG. 6 is a schematic perspective view of the first laminate exterior body of which a front region and a rear region are folded;

FIG. 7 is a sectional view taken along an arrow line VII-VII of FIG. 6;

FIG. 8 is a schematic perspective view of the first laminate exterior body of which a right region and a left region are folded;

FIG. 9 is a sectional view taken along an arrow line IX-IX of FIG. 8; and

FIG. 10 is a schematic side view showing a state where a plurality of batteries is stacked in a vertical direction.

### DETAILED DESCRIPTION OF EMBODIMENTS

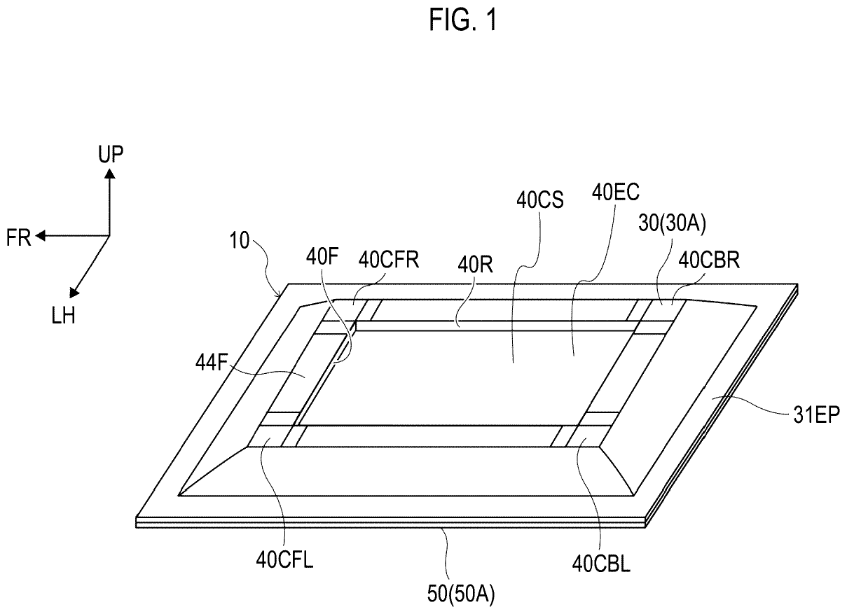

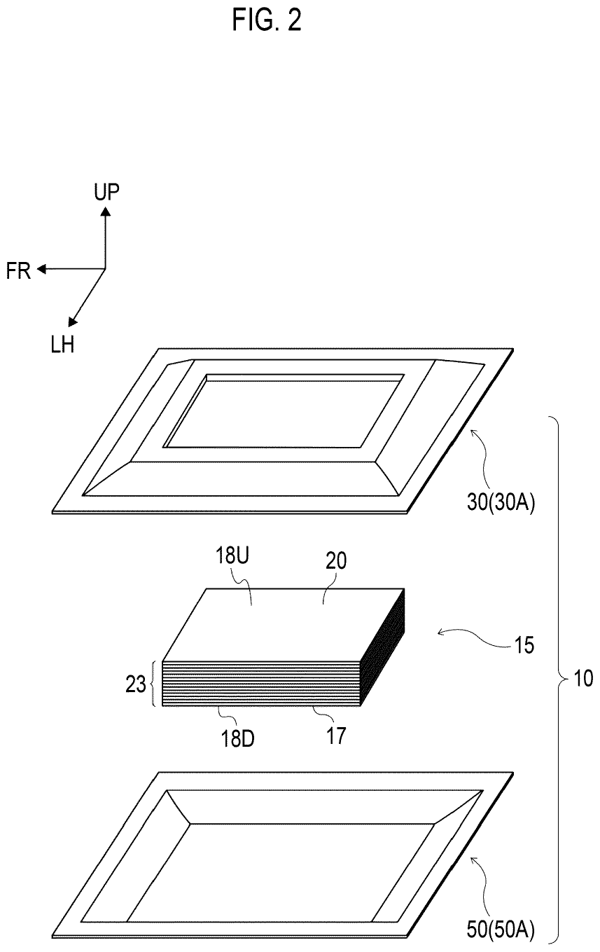

Hereinafter, a bipolar lithium-ion secondary battery (hereinafter, referred to as a battery 10) according to an embodiment will be described. The battery 10 of the present embodiment has a shape shown in FIG. 1, and as shown in FIG. 2, the battery 10 includes a laminate 15, a first laminate exterior body 30 (a laminate exterior body) (a first exterior constituting portion 30A), and a second laminate exterior body 50 (a laminate exterior body) (a second exterior constituting portion 50A) as components thereof. The battery 10 is mounted on a battery electric vehicle (BEV) and can supply electric power to an electric motor that is a drive source. Arrows UP, FR, and LH shown in each drawing indicate an upper side in a vehicle vertical direction, a front side in a vehicle front-rear direction, and a left side in a vehicle lateral direction, respectively.

The laminate 15 is obtained by laminating a plurality of electrodes and a plurality of separators in a predetermined lamination direction (a vertical direction in FIG. 1). As shown in FIG. 2, the electrodes include a negative terminal electrode 17 that constitutes a lower end portion of the laminate 15, a positive terminal electrode 20 that constitutes an upper end portion of the laminate 15, and a plurality of bipolar electrodes 23.

The negative terminal electrode 17 includes a current collector (an end portion current collector) 18D and a negative electrode active material layer (not shown) provided on one surface (an upper surface in FIG. 2) of the current collector 18D. The positive terminal electrode 20 includes a current collector (an end portion current collector) 18U and a positive electrode active material layer (not shown) provided on one surface (a lower surface in FIG. 2) of the current collector 18U. Each bipolar electrode 23 includes a current collector (not shown), a negative electrode active material layer (not shown) provided on a first surface (an upper surface in FIG. 2) of the current collector, and a positive electrode active material layer provided on a second surface (a lower surface in FIG. 2) of the current collector.

A separator (not shown) is provided between the negative electrode active material layer of the negative terminal electrode 17 and the positive electrode active material layer of the bipolar electrode 23 that is adjacent to the negative terminal electrode 17. Furthermore, a separator (not shown) is provided between the positive electrode active material layer of the positive terminal electrode 20 and the negative electrode active material layer of the bipolar electrode 23 that is adjacent to the positive terminal electrode 20. Furthermore, a separator (not shown) is provided between the negative electrode active material layer and the positive electrode active material layer of the bipolar electrodes 23 that are adjacent to each other.

Both end surfaces of the laminate 15 in the lamination direction are composed of the current collectors 18U, 18D. The laminate 15 is filled with a non-aqueous electrolyte (hereinafter, referred to as an electrolyte), and each negative electrode active material layer and each positive electrode active material layer are impregnated with the electrolyte.

Next, the first laminate exterior body 30 (the first exterior constituting portion 30A) and the second laminate exterior body 50 (the second exterior constituting portion 50A) will be described. The first laminate exterior body 30 and the second laminate exterior body 50 are up-down symmetric to each other. Therefore, in the following description, the first laminate exterior body 30 will be described in detail and the detailed description of the second laminate exterior body 50 will be omitted.

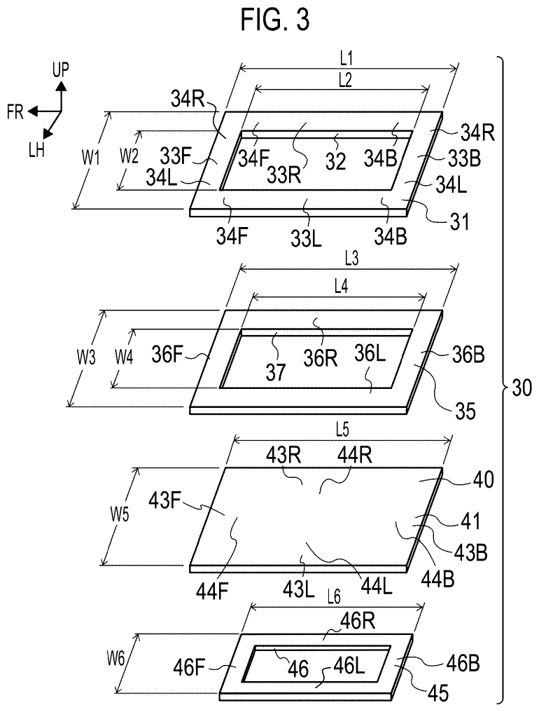

As shown in FIGS. 3 to 7, the first laminate exterior body 30 includes a laminate layer 31, a first sealant layer 35, a conductive layer 40, and a second sealant layer 45, which are all flexible sheet-shaped members.

As shown in FIG. 3, the unfolded shape of the laminate layer 31 is a rectangular shape of which the length in a front-rear direction is larger than the length thereof in a lateral direction. The entire surface of the laminate layer 31 is formed of a heat-fusible insulative resin. That is, both surfaces of the laminate layer 31 are formed of a heat-fusible resin laminate material. An opening portion 32 having a rectangular shape of which the length in the front-rear direction is larger than the length thereof in the lateral direction is formed in the laminate layer 31. A front-rear dimension of the laminate layer 31 is L1 and a front-rear dimension of the opening portion 32 is L2 when the laminate layer 31 is in an unfolded state. In addition, a lateral dimension of the laminate layer 31 is W1 and a lateral dimension of the opening portion 32 is W2 when the laminate layer 31 is in the unfolded state.

As shown in FIG. 3, the unfolded shape of the first sealant layer 35 which is insulative is a rectangular shape of which the length in the front-rear direction is larger 20 than the length thereof in the lateral direction. The first sealant layer 35 is formed of, for example, a thermoplastic resin, such as polyethylene, polypropylene, polystyrene, or polyvinyl chloride. An opening portion 37 having a rectangular shape of which the length in the front-rear direction is larger than the length thereof in the lateral direction is formed in the first sealant layer 35. A front-rear dimension of the first sealant layer 35 is L3 and a 25 front-rear dimension of the opening portion 37 is L4 when the first sealant layer 35 is in an unfolded state. In addition, a lateral dimension of the first sealant layer 35 is W3 and a lateral dimension of the opening portion 37 is W4 when the first sealant layer 35 is in the unfolded state. Note that L2=L4, W2=W4, L1>L3, and W1>W3.

As shown in FIG. 3, the unfolded shape of the conductive layer 40 formed of metal foil is a rectangular shape of which the length in the front-rear direction is larger than the length thereof in the lateral direction. A front-rear dimension of the conductive layer 40 is L5 and a lateral dimension of the conductive layer 40 is W5 when the conductive layer 40 is in an unfolded state.

As shown in FIG. 3, the unfolded shape of the second sealant layer 45 which is insulative is a rectangular shape of which the length in the front-rear direction is larger than the length thereof in the lateral direction. The second sealant layer 45 is formed of, for example, a thermoplastic resin, such as polyethylene, polypropylene, polystyrene, or polyvinyl chloride. An opening portion 46 having a rectangular shape of which the length in the front-rear direction is larger than the length thereof in the lateral direction is formed in the second sealant layer 45. A front-rear dimension of the second sealant layer 45 is L6 and a lateral dimension of the second sealant layer 45 is W6 when the second sealant layer 45 is in an unfolded state.

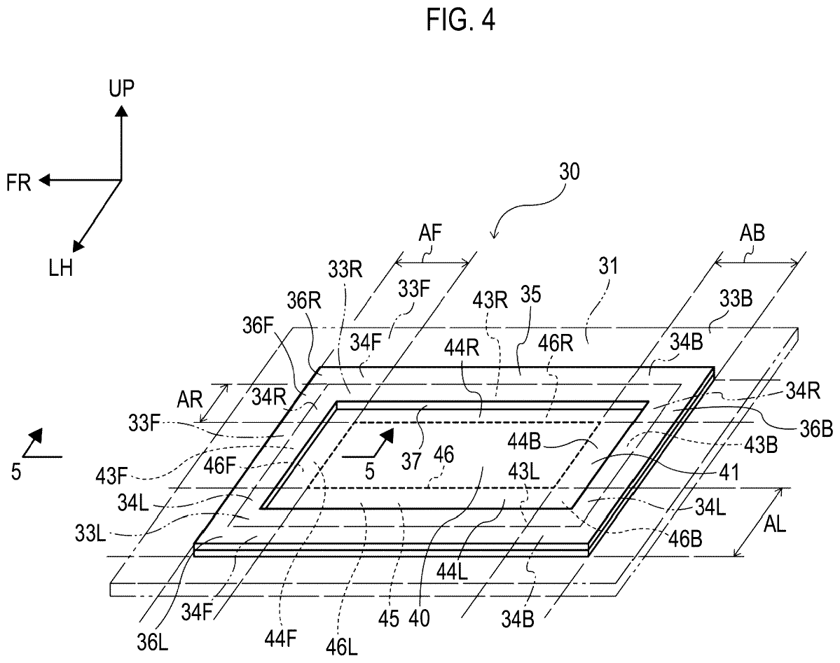

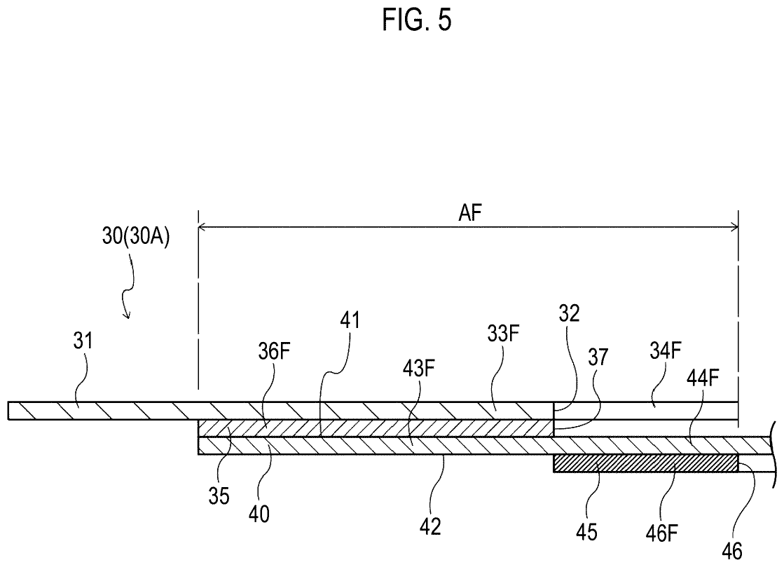

As shown in FIGS. 4 and 5, the first sealant layer 35 is placed on a first surface 41, which is a first surface of the conductive layer 40, and the first sealant layer 35 is fixed to the first surface 41. Note that L3=L5 and W3=W5, substantially. Therefore, an outer peripheral edge of the conductive layer 40 and an outer peripheral edge of the first sealant layer 35 substantially coincide with each other.

Furthermore, the second sealant layer 45 is in contact with a second surface 42, which is a second surface of the conductive layer 40, and the second sealant layer 45 is fixed to the second surface 42. Note that L6=L4<L5. In addition, W6=W4<W5. Therefore, in a view of the first laminate exterior body 30 as seen along a thickness direction (a vertical direction in FIGS. 3 and 4) of the first laminate exterior body 30, an outer peripheral edge of the second sealant layer 45 is positioned radially inward of an outer peripheral edge of the conductive layer 40 and substantially coincides with peripheral edge portions of the opening portion 32 of the laminate layer 31 and the opening portion 37 of the first sealant layer 35.

Furthermore, the laminate layer 31 is placed on an upper surface of the first sealant layer 35 and the laminate layer 31 is fixed to the first sealant layer 35. Note that L2=L4 and W2=W4, substantially. Therefore, the peripheral edge portion of the opening portion 37 of the first sealant layer 35 and the peripheral edge portion of the opening portion 32 of the laminate layer 31 substantially coincide with each other.

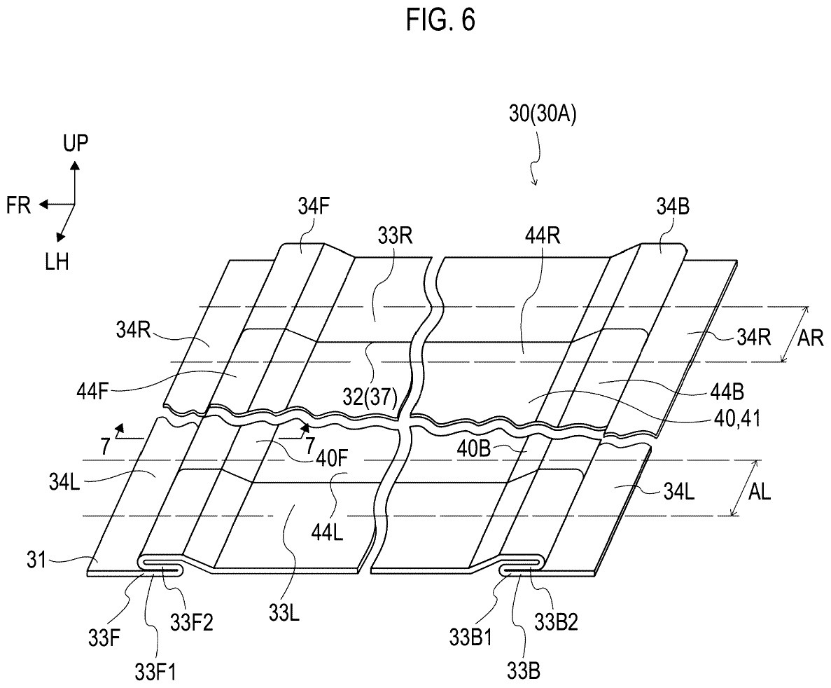

The first laminate exterior body 30 having such a structure is folded as shown in FIGS. 6 to 9. That is, a near-right-end portion and a near-left-end portion of the first laminate exterior body 30 are folded after a near-front-end portion and a near-rear-end portion of the first laminate exterior body 30 are folded. Hereinafter, a step of folding the near-front-end portion and the near-rear-end portion of the first laminate exterior body 30 will be referred to as a first folding step and a step of folding the near-right-end portion and the near-left-end portion of the first laminate exterior body 30 will be referred to as a second folding step.

First, a first folding step will be described with reference to FIGS. 4 to 7. In the first folding step, a front region AF, which is the near-front-end portion, and a rear region AB, which is the near-rear-end portion, of the first laminate exterior body 30 shown in FIGS. 4 and 5 are folded. In a plan view, a front edge portion of the front region AF coincides with front edge portions of the first sealant layer 35 and the conductive layer 40, and a rear edge portion of the front region AF coincides with a front edge portion of the opening portion 46 of the second sealant layer 45. In addition, in a plan view, a rear edge portion of the rear region AB coincides with rear edge portions of the first sealant layer 35 and the conductive layer 40, and a front edge portion of the rear region AB coincides with a rear edge portion of the opening portion 46.

Here, as shown in FIGS. 3 to 7, portions of the laminate layer 31 that are included in the front region AF are a front-side folding target portion 33F (a second folding target portion) that linearly extends in the lateral direction and that is positioned ahead of the opening portion 32 and a pair of right and left front-side surface constituting portions 34F that is adjacent to the front-side folding target portion 33F while being positioned behind the front-side folding target portion 33F. A front-side folding target portion (a first folding target portion) 36F, which is a portion of the first sealant layer 35 that linearly extends in the lateral direction and that is positioned ahead of the opening portion 37, is included in the front region AF. Portions of the conductive layer 40 that are included in the front region AF are a front-side folding target portion (a third folding target portion) 43F and a front-side surface constituting portion (a surface constituting portion) 44F that is adjacent to the front-side folding target portion 43F while being positioned behind the front-side folding target portion 43F, and a portion of the second sealant layer 45 that is included in the front region AF is a front-side folding target portion 46F.

Portions of the laminate layer 31 that are included in the rear region AB are a rear-side folding target portion (a second folding target portion) 33B that linearly extends in the lateral direction and that is positioned behind the opening portion 32 and a pair of right and left rear-side surface constituting portions 34B that is adjacent to the rear-side folding target portion 33B while being positioned ahead of the rear-side folding target portion 33B. A rear-side folding target portion (a first folding target portion) 36B, which is a portion of the first sealant layer 35 that linearly extends in the lateral direction and that is positioned behind the opening portion 37, is included in the rear region AB. Portions of the conductive layer 40 that are included in the rear region AB are a rear-side folding target portion (a third folding target portion) 43B and a rear-side surface constituting portion (a surface constituting portion) 44B that is adjacent to the rear-side folding target portion 43B while being positioned ahead of the rear-side folding target portion 43B, and a portion of the second sealant layer 45 that is included in the rear region AB is a rear-side folding target portion 46B.

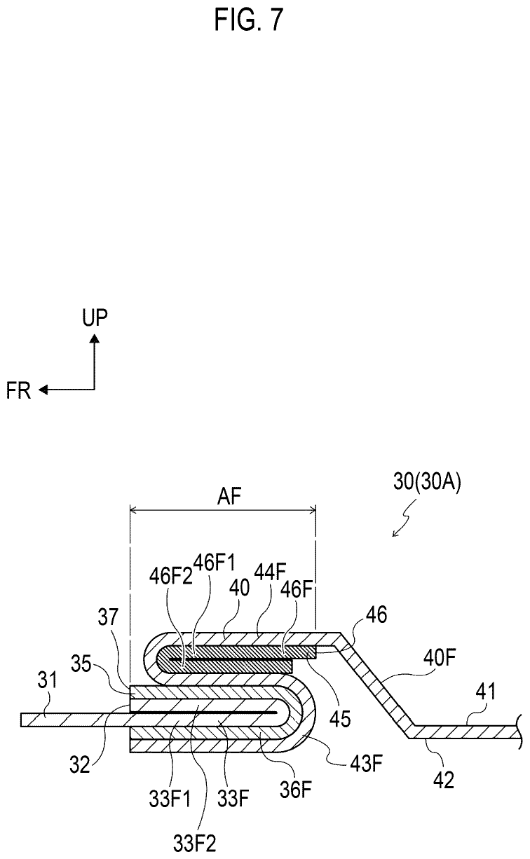

In the first folding step, the front region AF and the rear region AB are folded as shown in FIGS. 6 and 7 while being heated. That is, as shown in FIG. 7, the front-side folding target portion 33F, the front-side folding target portion 36F, and the front-side folding target portion 43F that are stacked on each other in the vertical direction (the thickness direction of the first laminate exterior body 30) are folded to have U-shaped sectional shapes that are open at an outer peripheral edge side of the first laminate exterior body 30 and the rear-side folding target portion 33B, the rear-side folding target portion 36B, and the rear-side folding target portion 43B that are stacked on each other in the vertical direction are folded to have U-shaped sectional shapes that are open at an outer peripheral edge side of the first laminate exterior body 30. At this time, a portion of the front-side folding target portion 33F becomes a first constituting portion 33F1, and the remainder of the front-side folding target portion 33F becomes a second constituting portion 33F2 that is stacked on the first constituting portion 33F1 in the vertical direction. Furthermore, the first constituting portion 33F1 and the second constituting portion 33F2 are thermally welded to each other. Therefore, the U-shaped sectional shapes of the front-side folding target portion 33F, the front-side folding target portion 36F, and the front-side folding target portion 43F are maintained. Although not shown in the drawings, at this time, a portion of the rear-side folding target portion 33B becomes a first constituting portion, and the remainder of the rear-side folding target portion 33B becomes a second constituting portion that is stacked on the first constituting portion in the vertical direction and that is thermally welded to the first constituting portion. Therefore, the U-shaped sectional shapes of the rear-side folding target portion 33B, the rear-side folding target portion 36B, and the rear-side folding target portion 43B are maintained.

Furthermore, as shown in FIGS. 6 and 7, in the first folding step, the front-side surface constituting portions 34F of the laminate layer 31, the front-side surface constituting portion 44F of the conductive layer 40, and the front-side folding target portion 46F of the second sealant layer 45 are folded to have U-shaped sectional shapes that are opposite to the sectional shapes of the front-side folding target portion 33F, the front-side folding target portion 36F, and the front-side folding target portion 43F. Similarly, the rear-side surface constituting portion 34B of the laminate layer 31, the rear-side surface constituting portion 44B of the conductive layer 40, and the rear-side folding target portion 46B of the second sealant layer 45 are folded to have U-shaped sectional shapes that are opposite to the sectional shapes of the rear-side folding target portion 33B, the rear-side folding target portion 36B, and the rear-side folding target portion 43B. As shown in FIG. 7, at this time, a portion of the front-side folding target portion 46F becomes a first portion 46F1 that is fixed to the front-side surface constituting portion 44F and the remainder of the front-side folding target portion 46F becomes a second portion 46F2 that is fixed to the front-side folding target portion 43F, that is stacked on the first portion 46F1 in the vertical direction, and that is thermally welded to the first portion 46F1. Therefore, the U-shaped sectional shapes of the front-side surface constituting portions 34F and the front-side folding target portion 46F are maintained. Although not shown in the drawings, at this time, a portion of the rear-side folding target portion 46B becomes a first portion, and the remainder of the rear-side folding target portion 46B becomes a second portion that is stacked on the first portion in the vertical direction and that is thermally welded to the first portion. Therefore, the U-shaped sectional shapes of the rear-side surface constituting portions 34B (refer to FIG. 6) and the rear-side folding target portion 46B are maintained. Furthermore, as shown in FIG. 6, a portion of the front-side surface constituting portion 44F of the conductive layer 40 and a portion of the rear-side surface constituting portion 44B of the conductive layer 40 are planar to be approximately orthogonal to the vertical direction.

Furthermore, as shown in FIG. 6, the first laminate exterior body 30 is folded such that a portion of the first laminate exterior body 30 that is adjacent to the front-side surface constituting portions 34F, 44F while being positioned behind the front-side surface constituting portions 34F, 44F and a portion of the first laminate exterior body 30 that is adjacent to the rear-side surface constituting portions 34B, 44B while being positioned ahead of the rear-side surface constituting portions 34B, 44B are inclined with respect to the front-rear direction and the vertical direction as seen in the lateral direction. The conductive layer 40 made of metal has a function of maintaining the shape thereof. Therefore, even when a force applied to the first laminate exterior body 30 to fold the first laminate exterior body 30 disappears, the inclined shape is maintained. That is, a front-side inclined portion 40F and a rear-side inclined portion 40B are formed at a portion of the conductive layer 40 that is adjacent to the front-side surface constituting portion 44F and a portion of the conductive layer 40 that is adjacent to the rear-side surface constituting portion 44B, respectively.

Next, the second folding step will be described with reference to FIGS. 4, 6, 8, and 9. In the second folding step, a left region AL, which is the near-left-end portion, and a right region AR, which is the near-right-end portion, of the first laminate exterior body 30 shown in FIG. 6 are folded. In a plan view, a left-side edge portion of the left region AL coincides with left-side edge portions of the first sealant layer 35 and the conductive layer 40, and a right-side edge portion of the left region AL coincides with a left-side edge portion of the opening portion 46 of the second sealant layer 45. In addition, in a plan view, a right-side edge portion of the right region AR coincides with right-side edge portions of the first sealant layer 35 and the conductive layer 40, and a left-side edge portion of the right region AR coincides with a right-side edge portion of the opening portion 46.

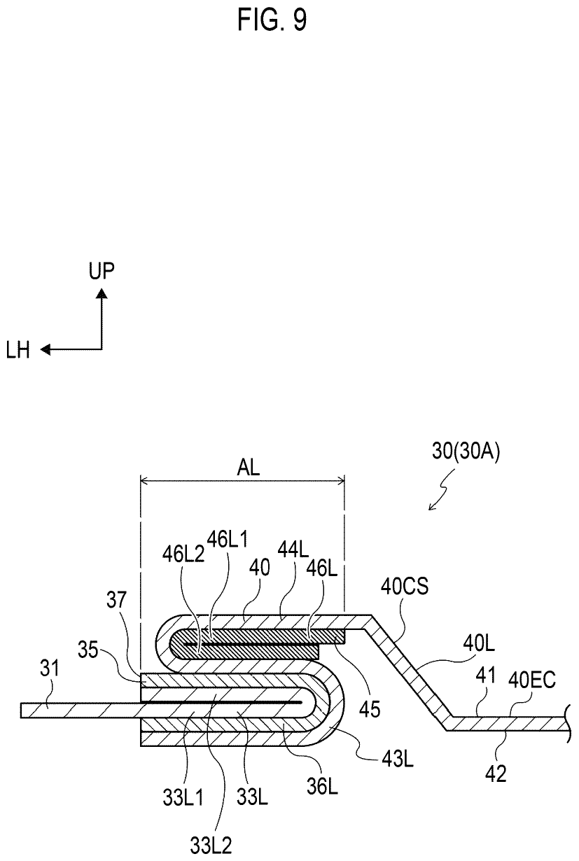

Here, as shown in FIGS. 6 and 9, portions of the laminate layer 31 that are included in the left region AL are a left-side folding target portion (a second folding target portion) 33L that linearly extends in the front-rear direction and that is positioned to the left of the opening portion 32 and a pair of front and rear left-side surface constituting portions 34L that is adjacent to the left-side folding target portion 33L while being positioned to the right of the left-side folding target portion 33L. A left-side folding target portion (a first folding target portion) 36L, which is a portion of the first sealant layer 35 that linearly extends in the front-rear direction and that is positioned to the left of the opening portion 37, is included in the left region AL. Portions of the conductive layer 40 that are included in the left region AL are a left-side folding target portion (a third folding target portion) 43L and a left-side surface constituting portion (a surface constituting portion) 44L that is adjacent to the left-side folding target portion 43L while being positioned to the right of the left-side folding target portion 43L, and a portion of the second sealant layer 45 that is included in the left region AL is a left-side folding target portion 46L.

Portions of the laminate layer 31 that are included in the right region AR are a right-side folding target portion (a second folding target portion) 33R that linearly extends in the front-rear direction and that is positioned to the right of the opening portion 32 and a pair of front and rear right-side surface constituting portions 34R that is adjacent to the right-side folding target portion 33R while being positioned to the left of the right-side folding target portion 33R. A right-side folding target portion (a first folding target portion) 36R, which is a portion of the first sealant layer 35 that linearly extends in the front-rear direction and that is positioned to the right of the opening portion 37, is included in the right region AR. Portions of the conductive layer 40 that are included in the right region AR are a right-side folding target portion (a third folding target portion) 43R and a right-side surface constituting portion (a surface constituting portion) 44R that is adjacent to the right-side folding target portion 43R while being positioned to the left of the right-side folding target portion 43R, and a portion of the second sealant layer 45 that is included in the right region AR is a right-side folding target portion 46R.

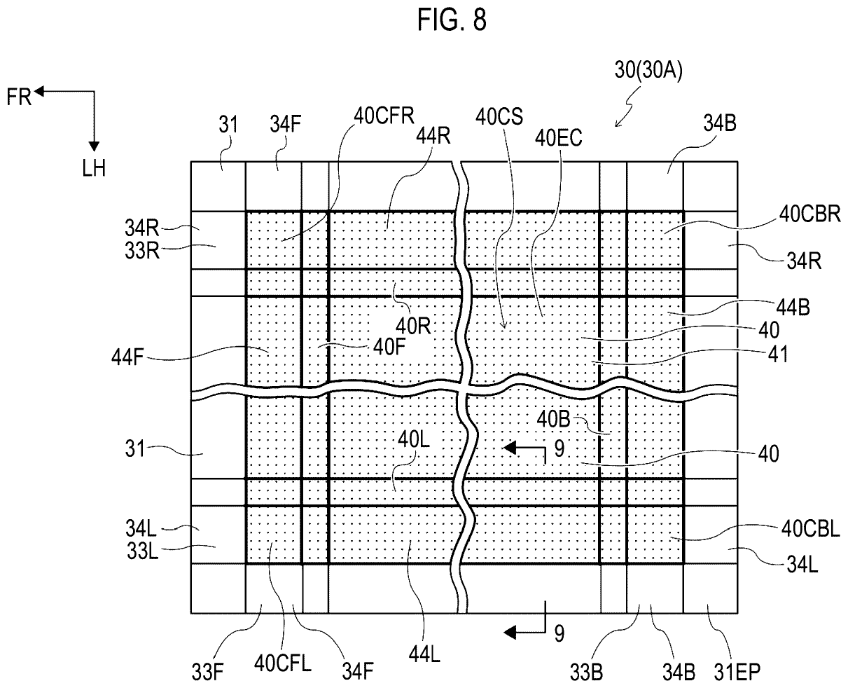

In the second folding step, the left region AL and the right region AR are folded as shown in FIGS. 8 and 9 while being heated. That is, the left-side folding target portion 33L, the left-side folding target portion 36L, and the left-side folding target portion 43L that are stacked on each other in the vertical direction are folded to have U-shaped sectional shapes that are open at an outer peripheral edge side of the first laminate exterior body 30 and the right-side folding target portion 33R, the right-side folding target portion 36R, and the right-side folding target portion 43R that are stacked on each other in the vertical direction are folded to have U-shaped sectional shapes that are open at an outer peripheral edge side of the first laminate exterior body 30. At this time, a portion of the left-side folding target portion 33L becomes a first constituting portion 33L1, and the remainder of the left-side folding target portion 33L becomes a second constituting portion 33L2 that is stacked on the first constituting portion 33L1 in the vertical direction. Furthermore, the first constituting portion 33L1 and the second constituting portion 33L2 are thermally welded to each other. Therefore, the U-shaped sectional shapes of the left-side folding target portion 33L, the left-side folding target portion 36L, and the left-side folding target portion 43L are maintained. Although not shown in the drawings, at this time, a portion of the right-side folding target portion 33R becomes a first constituting portion, and the remainder of the right-side folding target portion 33R becomes a second constituting portion that is stacked on the first constituting portion in the vertical direction and that is thermally welded to the first constituting portion. Therefore, the U-shaped sectional shapes of the right-side folding target portion 33R, the right-side folding target portion 36R, and the right-side folding target portion 43R are maintained.

Furthermore, in the second folding step, the left-side surface constituting portions 34L of the laminate layer 31, the left-side surface constituting portion 44L of the conductive layer 40, and the left-side folding target portion 46L of the second sealant layer 45 are folded to have U-shaped sectional shapes that are opposite to the sectional shapes of the left-side folding target portion 33L, the left-side folding target portion 36L, and the left-side folding target portion 43L and the right-side surface constituting portions 34R of the laminate layer 31, the right-side surface constituting portion 44R of the conductive layer 40, and the right-side folding target portion 46R of the second sealant layer 45 are folded to have U-shaped sectional shapes that are opposite to the sectional shapes of the right-side folding target portion 33R, the right-side folding target portion 36R, and the right-side folding target portion 43R. As shown in FIG. 9, at this time, a portion of the left-side folding target portion 46L becomes a first portion 46L1 that is fixed to the left-side surface constituting portion 44L and the remainder of the left-side folding target portion 46L becomes a second portion 46L2 that is fixed to the left-side folding target portion 43L, that is stacked on the first portion 46L1 in the vertical direction, and that is thermally welded to the first portion 46L1. Therefore, the U-shaped sectional shapes of the left-side surface constituting portions 34L and the left-side folding target portion 46L are maintained. Although not shown in the drawings, at this time, a portion of the right-side folding target portion 46R becomes a first portion, and the remainder of the right-side folding target portion 46R becomes a second portion that is stacked on the first portion in the vertical direction and that is thermally welded to the first portion. Therefore, the U-shaped sectional shapes of the right-side surface constituting portions 34R and the right-side folding target portion 46R are maintained. Furthermore, a portion of the left-side surface constituting portion 44L of the conductive layer 40 and a portion of the right-side surface constituting portion 44R of the conductive layer 40 are planar to be approximately orthogonal to the vertical direction.

Furthermore, the first laminate exterior body 30 is folded such that a portion of the first laminate exterior body 30 that is adjacent to the left-side surface constituting portions 34L and the left-side surface constituting portion 44L while being positioned to the right of the left-side surface constituting portions 34L and the left-side surface constituting portion 44L and a portion of the first laminate exterior body 30 that is adjacent to the right-side surface constituting portions 34R and the right-side surface constituting portion 44R while being positioned to the left of the right-side surface constituting portions 34R and the right-side surface constituting portion 44R are inclined with respect to the lateral direction and the vertical direction as seen in the front-rear direction. The conductive layer 40 made of metal has a function of maintaining the shape thereof. Therefore, even when a force applied to the first laminate exterior body 30 to fold the first laminate exterior body 30 disappears, the inclined shape is maintained. That is, as shown in FIG. 8, a left-side inclined portion 40L and a right-side inclined portion 40R are formed at a portion of the conductive layer 40 that is adjacent to the left-side surface constituting portion 44L and a portion of the conductive layer 40 that is adjacent to the right-side surface constituting portion 44R, respectively. Furthermore, as shown in FIG. 8, a region between the front-side inclined portion 40F, the rear-side inclined portion 40B, the left-side inclined portion 40L, and the right-side inclined portion 40R of the conductive layer 40 is a conductive portion 40EC that is planar to be orthogonal to the vertical direction. Note that a region represented by a large number of circles in FIG. 8 is the conductive layer 40.

When the first folding step and the second folding step are completed in this manner, the first laminate exterior body 30 becomes the first exterior constituting portion 30A shown in FIG. 8. An outer peripheral portion of the first exterior constituting portion 30A is an outer peripheral welding target portion 31EP that is composed of an outer peripheral portion of the laminate layer 31 and that has an approximately rectangular frame-like shape as seen in a plan view. Furthermore, in a view of the first exterior constituting portion 30A as seen along the vertical direction, the front-side folding target portion 33F, the rear-side folding target portion 33B, the left-side folding target portion 33L, the right-side folding target portion 33R, the front-side folding target portion 36F, the rear-side folding target portion 36B, the left-side folding target portion 36L, the right-side folding target portion 36R, the front-side folding target portion 43F, the rear-side folding target portion 43B, the left-side folding target portion 43L, the right-side folding target portion 43R, the front-side folding target portion 46F, the rear-side folding target portion 46B, the left-side folding target portion 46L, and the right-side folding target portion 46R are positioned radially outward of the center of the conductive portion 40EC in an annular shape. Furthermore, the front-side surface constituting portion 44F, the rear-side surface constituting portion 44B, the left-side surface constituting portion 44L, and the right-side surface constituting portion 44R of the conductive layer 40 are positioned above the conductive portion 40EC. That is, a space surrounded by the conductive portion 40EC, the front-side inclined portion 40F, the rear-side inclined portion 40B, the left-side inclined portion 40L, and the right-side inclined portion 40R is an adhesive injection space 40CS. Furthermore, a connection region 40CFL that is configured with the front-side surface constituting portion 44F and the left-side surface constituting portion 44L intersecting each other and that is approximately square as seen in a plan view, a connection region 40CFR that is configured with the front-side surface constituting portion 44F and the right-side surface constituting portion 44R intersecting each other and that is approximately square as seen in a plan view, a connection region 40CBL that is configured with the rear-side surface constituting portion 44B and the left-side surface constituting portion 44L intersecting each other and that is approximately square as seen in a plan view, and a connection region 40CBR that is configured with the rear-side surface constituting portion 44B and the right-side surface constituting portion 44R intersecting each other and that is approximately square as seen in a plan view are positioned at the highest positions at the first exterior constituting portion 30A and are approximately orthogonal to the vertical direction. Note that when the second laminate exterior body 50 that is up-down symmetric to the first laminate exterior body 30 is processed by being subjected to the first folding step and the second folding step, the second laminate exterior body 50 becomes the second exterior constituting portion 50A up-down symmetric to the first exterior constituting portion 30A.

After the first exterior constituting portion 30A and the second exterior constituting portion 50A are completed in this manner, the laminate 15 is positioned between the first exterior constituting portion 30A and the second exterior constituting portion 50A, a lower surface of the conductive portion 40EC of the first exterior constituting portion 30A is brought into contact with the current collector 18U of the laminate 15, and an upper surface of the conductive portion 40EC of the second exterior constituting portion 50A is brought into contact with the current collector 18D of the laminate 15. Furthermore, the entire outer peripheral welding target portion 31EP of the first exterior constituting portion 30A and the entire outer peripheral welding target portion 31EP of the second exterior constituting portion 50A are thermally welded to each other. As a result, the battery 10 shown in FIG. 1 is completed.

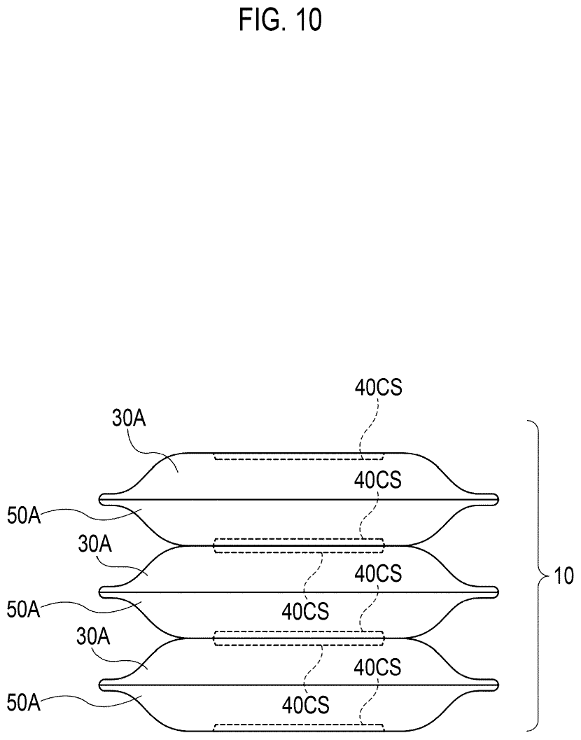

When a plurality of batteries 10 configured as described above is manufactured, the batteries 10 are stacked onto each other in the vertical direction as shown in FIG. 10. At this time, the connection regions 40CFL, 40CFR, 40CBL, 40CBR of the first exterior constituting portion 30A of one battery 10 are brought into contact with portions (hereinafter, corresponding portions) of the second exterior constituting portion 50A of the battery 10 positioned directly above the one battery 10, respectively, the corresponding portions corresponding to the connection regions 40CFL, 40CFR, 40CBL, 40CBR. Furthermore, the adhesive injection space 40CS of each battery 10, directly above which another battery 10 is positioned, is filled with a conductive liquid adhesive (not shown). Therefore, a portion of the adhesive filling the adhesive injection space 40CS adheres to a portion of a lower surface of the second exterior constituting portion 50A of the battery 10 that is positioned directly above the battery 10 including the adhesive injection space 40CS. Therefore, when the adhesive is cured, the batteries 10 that are adjacent to each other are fixed to each other by the adhesive and the connection regions 40CFL, 40CFR, 40CBL, 40CBR of the first exterior constituting portion 30A of the battery 10 and the corresponding portions of the second exterior constituting portion 50A of the battery 10 positioned directly above the battery 10 are brought into contact with each other.

Therefore, electric power generated by each battery 10 can be supplied to various electrical devices and electronic devices (not shown) provided in the battery electric vehicle via a conductive member (not shown) connected to the conductive portion 40EC of the second exterior constituting portion 50A of the battery 10 that is positioned at the lowermost position and a conductive member (not shown) connected to the conductive portion 40EC of the first exterior constituting portion 30A of the battery 10 that is positioned at the uppermost position.

### Operation and Effect

Next, the operation and effect of the present embodiment will be described.

The first laminate exterior body 30 (the first exterior constituting portion 30A) and the second laminate exterior body 50 (the second exterior constituting portion 50A) of each battery 10 include the conductive layers 40 that are electrically connected to the current collectors 18U, 18D of the electrodes at both end portions of the laminate 15 in the lamination direction, the first sealant layers 35 provided on the first surfaces 41 of the conductive layers 40, and the laminate layers 31 provided on surfaces of the first sealant layers 35 that are on the opposite sides of the first sealant layers 35 from the conductive layers 40. Furthermore, the front-side folding target portions 36F, the rear-side folding target portions 36B, the left-side folding target portions 36L, the right-side folding target portions 36R, the front-side folding target portions 33F, the rear-side folding target portions 33B, the left-side folding target portions 33L, the right-side folding target portions 33R, the front-side folding target portions 43F, the rear-side folding target portions 43B, the left-side folding target portions 43L, and the right-side folding target portions 43R of the first laminate exterior body 30 and the second laminate exterior body 50 that are stacked in the thickness direction are folded to form U-shapes that are open at outer peripheral edge sides of the first exterior constituting portion 30A and the second exterior constituting portion 50A. Therefore, the total length of a seal structure that is formed between the front-side folding target portion 36F, the rear-side folding target portion 36B, the left-side folding target portion 36L, the right-side folding target portion 36R, the front-side folding target portion 33F, the rear-side folding target portion 33B, the left-side folding target portion 33L, the right-side folding target portion 33R, the front-side folding target portion 43F, the rear-side folding target portion 43B, the left-side folding target portion 43L, and the right-side folding target portion 43R and in which the first sealant layer 35 is used can be made large without an increase in dimensions of the entire first sealant layer 35 and an increase in dimensions of the entire battery 10. Furthermore, in a view of the first exterior constituting portion 30A and the second exterior constituting portion 50A as seen along the vertical direction, the front-side folding target portions 33F, the rear-side folding target portions 33B, the left-side folding target portions 33L, the right-side folding target portions 33R, the front-side folding target portions 36F, the rear-side folding target portions 36B, the left-side folding target portions 36L, the right-side folding target portions 36R, the front-side folding target portions 43F, the rear-side folding target portions 43B, the left-side folding target portions 43L, the right-side folding target portions 43R, the front-side folding target portions 46F, the rear-side folding target portions 46B, the left-side folding target portions 46L, and the right-side folding target portions 46R are positioned radially outward of the centers of the conductive portions 40EC in an annular shape. Therefore, a foreign substance (for example, moisture) in a space radially outward of the battery 10 is less likely to enter, from between the laminate layers 31, the first sealant layers 35, and the conductive layers 40 of the first exterior constituting portion 30A and the second exterior constituting portion 50A, a space radially inward of the first exterior constituting portion 30A and the second exterior constituting portion 50A that is surrounded by the first exterior constituting portion 30A and the second exterior constituting portion 50A.

Furthermore, the first exterior constituting portion 30A and the second exterior constituting portion 50A of each battery 10 include the second sealant layers 45 provided on the second surfaces 42 of the conductive layers 40. Furthermore, each conductive layer 40 includes the front-side surface constituting portion 44F, the rear-side surface constituting portion 44B, the left-side surface constituting portion 44L, and the right-side surface constituting portion 44R that are stacked on the front-side folding target portion 43F, the rear-side folding target portion 43B, the left-side folding target portion 43L, and the right-side folding target portion 43R from outside. Furthermore, each second sealant layer 45 includes the first portions (the first portion 46F1 and the first portion 46L1) that are positioned between the front-side surface constituting portion 44F, the rear-side surface constituting portion 44B, the left-side surface constituting portion 44L, the right-side surface constituting portion 44R, the front-side folding target portion 43F, the rear-side folding target portion 43B, the left-side folding target portions 43L, and the right-side folding target portion 43R and that are provided on the second surfaces 42 of the front-side surface constituting portion 44F, the rear-side surface constituting portion 44B, the left-side surface constituting portion 44L, and the right-side surface constituting portion 44R and the second portions (the second portion 46F2 and the second portion 46L2) that are provided on the second surfaces 42 of the third folding target portions and that are welded to the first portions. Therefore, in comparison with a case where the battery 10 does not include the first portions and the second portions, a foreign substance (for example, moisture) in the space radially outward of the battery 10 is less likely to enter, from between the laminate layers 31, the first sealant layers 35, and the conductive layers 40 of the first exterior constituting portion 30A and the second exterior constituting portion 50A, the space radially inward of the first exterior constituting portion 30A and the second exterior constituting portion 50A that is surrounded by the first exterior constituting portion 30A and the second exterior constituting portion 50A.

Furthermore, the front-side surface constituting portion 44F, the rear-side surface constituting portion 44B, the left-side surface constituting portion 44L, and the right-side surface constituting portion 44R of the conductive layer 40 of the first exterior constituting portion 30A of each battery 10 are positioned above the conductive portion 40EC. Therefore, a large amount of adhesive is less likely to suddenly move to the front-side surface constituting portion 44F, the rear-side surface constituting portion 44B, the left-side surface constituting portion 44L, and the right-side surface constituting portion 44R when the adhesive injection space 40CS is filled with a liquid adhesive. Therefore, the batteries 10 that are adjacent to each other can be easily connected to each other via an adhesive.

Furthermore, the connection regions 40CFL, 40CFR, 40CBL, 40CBR of the first exterior constituting portion 30A are positioned at the highest positions at the first exterior constituting portion 30A and are planar surfaces approximately orthogonal to the vertical direction. Similarly, each corresponding portion of the second exterior constituting portion 50A is positioned at the lowest position at the second exterior constituting portion 50A and is a planar surface approximately orthogonal to the vertical direction. When the batteries 10 are to be stacked in the vertical direction, two batteries 10 are fixed to each other while the connection regions 40CFL, 40CFR, 40CBL, 40CBR of the first exterior constituting portion 30A of one battery 10 are brought into contact with the corresponding portions of the second exterior constituting portion 50A of the battery 10 positioned directly above the one battery 10, respectively. Therefore, even in a case where a wrinkle (unevenness) is on a surface of a portion different from the connection regions 40CFL, 40CFR, 40CBL, 40CBR of the first exterior constituting portion 30A and a surface of a portion different from the corresponding portions of the second exterior constituting portion 50A, the upper and lower batteries 10 can be fixed in a stable state.

Furthermore, the first sealant layer 35 is provided between the laminate layer 31 and the conductive layer 40. Therefore, even in a case where there are holes formed in the laminate layer 31 of the first exterior constituting portion 30A of one battery 10 and the laminate layer 31 of the second exterior constituting portion 50A of another battery 10 positioned directly above the one battery 10, a short circuit that occurs between the conductive layers 40 of the two batteries 10 through the two holes is prevented by the first sealant layer 35.

Although the battery 10 according to the embodiment has been described above, the design of the battery 10 can be changed as appropriate without departing from the scope of the disclosure.

For example, the laminate 15 may be composed of a solid-state battery that does not include an electrolyte.

What is claimed is:

1. A battery comprising:
a laminate that is obtained by laminating a plurality of electrodes including current collectors in a predetermined lamination direction; and
a pair of laminate exterior bodies that covers the entire laminate with the laminate exterior bodies thermally welded to each other in a state where the entire laminate is interposed between the laminate exterior bodies, wherein:
each of the laminate exterior bodies includes
a conductive layer that is electrically connected to end portion current collectors that are the current collectors of the electrodes at both end portions of the laminate in the lamination direction,
a first sealant layer that is provided on a first surface of the conductive layer that is a surface on an opposite side of the conductive layer from the laminate, and
a laminate layer that is provided on a surface of the first sealant layer that is on an opposite side of the first sealant layer from the conductive layer;
a first folding target portion that is a portion of the first sealant layer, a second folding target portion that is a portion of the laminate layer, and a third folding target portion that is a portion of the conductive layer are stacked on each other in a thickness direction of the laminate exterior body; and
the first folding target portion, the second folding target portion, and the third folding target portion are folded to have U-shaped sectional shapes.

2. The battery according to claim 1, wherein:
the laminate layer includes an opening portion through which a portion of the conductive layer is exposed; and
the first folding target portion, the second folding target portion, and the third folding target portion are positioned radially outward of a center of the opening portion in an annular shape as a whole in a view of the laminate exterior body before being folded as seen in the thickness direction.

3. The battery according to claim 2, wherein:
the first folding target portion is folded to have a U-shaped sectional shape that is open at an outer peripheral edge side of the laminate exterior body;
the second folding target portion is folded to have a U-shaped sectional shape that is open at the outer peripheral edge side in a space radially inward of the first folding target portion; and
the third folding target portion is folded to have a U-shaped sectional shape that is open at the outer peripheral edge side at a position radially outward of the first folding target portion.

4. The battery according to claim 2, wherein:
the conductive layer includes
a conductive portion that is positioned in the opening portion in a view of the laminate exterior body as seen in the thickness direction and that is electrically connected to the end portion current collector, and
a surface constituting portion that is positioned outward of the third folding target portion; and
when the opening portion is caused to face an upper side, the surface constituting portion is positioned above the conductive portion.

5. The battery according to claim 4, wherein:
the laminate exterior body includes a second sealant layer that is provided on a second surface of the conductive layer that is a surface on a laminate side; and
the second sealant layer includes a first portion that is positioned between the surface constituting portion and the third folding target portion and that is provided on a second surface of the surface constituting portion and a second portion that is provided on a second surface of the third folding target portion and that is welded to the first portion.

6. The battery according to claim 1, wherein the laminate is composed of a solid-state battery.
